(19) United States
(12) Patent Application Publication
(10) Pub. No.: US 2014/0016124 A1
(43) Pub. Date: Jan. 16, 2014

(54) OPTICAL INSPECTION DEVICE

(71) Applicant: MPI CORPORATION, Chu-Pei City (TW)

(72) Inventors: Chia-Tai CHANG, Chu-Pei City (TW); Chin-Yi TSAI, Chu-Pei City (TW); Chiu-Kuei CHEN, Chu-Pei City (TW); Chen-Chih YU, Chu-Pei City (TW); Chien-Chang LAI, Chu-Pei City (TW); Chin-Tien YANG, Chu-Pei City (TW); Hui-Pin YANG, Chu-Pei City (TW); Keng-Shieng CHANG, Chu-Pei City (TW); Yun-Ru HUANG, Chu-Pei City (TW); Chien-Hung CHEN, Chu-Pei City (TW)

(21) Appl. No.: 13/941,009

(22) Filed: Jul. 12, 2013

(30) Foreign Application Priority Data
Jul. 13, 2012 (TW) 101213567
Feb. 8, 2013 (TW) 102105460
Mar. 1, 2013 (TW) 102203849

(51) Int. Cl. G01N 21/88

(52) U.S. Cl. CPC G01N 21/88
USPC 356/237.1

(57) ABSTRACT

An optical inspection device includes a circuit board having at least one first opening, a mounting plate disposed on a top or bottom surface of the circuit board and having at least one second opening corresponding to the at least one first opening respectively, at least one lens holder received in the at least one second opening, and at least one probe module disposed on a bottom surface of the mounting plate or the bottom surface of the circuit board, corresponding to the at least one lens holder respectively, and having probes electrically connected with the circuit board. Each lens holder has an accommodation for accommodating a lens, and is operatable to do a position adjusting motion in the corresponding second opening.

### CROSS-REFERENCE TO RELATED APPLICATIONS

This application claims priorities from Taiwan Patent Application No. 101213567 filed on Jul. 13, 2012, Taiwan Patent Application No. 102105460 filed on Feb. 8, 2013 and Taiwan Patent Application No. 102203849 filed on Mar. 1, 2013, the entire contents of which are incorporated herein by reference.

### BACKGROUND OF THE INVENTION

1. Field of the Invention

The present invention relates to probing apparatuses and more particularly, to an optical inspection device having a lens holder and a position adjusting mechanism for driving the lens holder to do a position adjusting motion.

2. Description of the Related Art

The conventional wafer-level testing includes the procedures of probing the contact pads on the wafer and transmitting and measuring the test signals from a tester by a probe card. In this way, the wire connecting reliability and conductivity of the integrated circuits in every manufacturing process and step can be learned, and the manufacturing factors or steps that may cause any circuit defect can be speedily determined or corrected so as to increase the yield in manufacturing.

FIG. 1A is a schematic lateral side view of a probing structure of a prior art used in a wafer-level testing. In this prior art design, the wafer-level probing structure is composed of a mounting plate 4 provided with a plurality of openings 41, each of which is adapted for accommodating a lens holder 11 therein. Each lens holder 11 is provided at an inside thereof with an accommodation for being screwingly coupled with a lens 12 through a thread 121. The disadvantage of this prior art design lies in that the position of the lens 12 can not be easily and precisely adjusted. Specifically speaking, each lens 12 has a fixed focus and it is needed to let the focus of the lens 12 be lain exactly on the device under test by adjusting the position of the lens 12, such that a clear image may generate. In the aforesaid prior art, the fine adjustment of the focus is carried out by adjusting the engagement relationship between the thread 121 on the periphery wall of the lens 12 and the thread provided inside the lens holder 11 so as to change the position of the lens 12 in the vertical direction. This adjusting work is however very inconvenient and thus adversely affects the probing efficiency. In addition, the backlash between the thread provided on the inner wall of the lens holder 11 and the thread 121 on the lens 12 will usually cause error in the position adjusting operation of the lens 12 to adversely affect the optical image-forming effect.

FIG. 1B schematically shows a lateral side view of an optical inspection device according to a prior art. As shown in FIG. 1B, a plurality of diffusers 54 for uniformly diffusing light are used in order to enhance the effect of optical inspection. To introduce the diffusers 54 into the optical inspection device, a substrate 51 having a plurality of openings 53 is firstly mounted on the top surface of the lens holder 50 in such a way that the openings 53 are aimed at the lenses 52, respectively, then the diffusers 54 are mounted on the locations of the substrate 51 corresponding to the openings 53 respectively, and then fixing and reinforcing members 55 are used to hold the diffusers 54 in position respectively. In this prior design, when it is needed to adjust the focus of the lens 52 subject to various devices under test, the fixing and reinforcing member 55 and the diffuser 54 need to be detached from the substrate 51 firstly, and then the lens 52 needs to be driven to turn for adjusting its focus. This focus-adjusting operation is inconvenient and complicated, thereby increasing the complexity of the testing operation.

In light of the above, it is desired to provide an optical inspection device that can solve the problems of the above-mentioned prior arts.

### SUMMARY OF THE INVENTION

The present invention has been accomplished under the circumstances in view. It is an objective of the present invention to provide an optical inspection device equipped with a lens adjusting mechanism, which is provided with threads and at least one adjustment notch at a top portion of a lens holder, such that the position of the lens holder carrying a lens therein can be simply adjusted by an adjustment jig.

It is another objective of the present invention to provide an optical inspection device, which has a flexible ring sleeved onto the lens holder to prevent the lens holder from slip.

It is still another objective of the present invention to provide an optical inspection device, which is provided with a scale on a top surface surrounding an opening of an accommodation of the lens holder and a pointer on a surface surrounding an opening of a mounting plate such that the position adjusting motion of the lens holder can be learned and confirmed.

It is still another objective of the present invention to provide an optical inspection device, which has the lens holder without any flange such that the total volume of the lens holder can be reduced.

It is still another objective of the present invention to provide an optical inspection device, which has a detachable optic modulating member for modulating light, e.g. diffusing light or filtering light, and is provided with a lens adjusting mechanism that can directly adjust the focus of the lens without disassembly of the optic modulating member.

To achieve the above-mentioned objectives, an optical inspection device provided by the present invention comprises a circuit board, a mounting plate, at least one lens holder, and at least one probe module. The circuit board has at least one first opening. The mounting plate is disposed on a top surface or a bottom surface of the circuit board and provided with at least one second opening corresponding to the at least one first opening respectively. The at least one lens holder is received in the at least one second opening. Each lens holder is provided with an accommodation for accommodating a lens, and operatable to do a position adjusting motion in the corresponding second opening. The at least one probe module is disposed on a bottom surface of the mounting plate or the bottom surface of the circuit board corresponding to the at least one lens holder respectively. The probe module has a plurality of probes electrically connected with the circuit board.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1A is a schematic lateral side view of a probing structure of a prior art used in a wafer-level testing;

FIG. 1B is a schematic lateral side view of an optical inspection device equipped with diffusers according to a prior art;

FIGS. 2A and 2B are schematic cross-sectional views of an optical inspection device according to an embodiment of the present invention;

FIGS. 3A to 3C are schematic perspective views of a lens adjusting mechanism of the optical inspection device according to various embodiments of the present invention;

FIG. 4A is a schematic perspective view of a lens adjusting mechanism having an optic modulating member of the optical inspection device according to an embodiment of the present invention;

FIG. 4B is a cross-sectional view taken along the line 4B-4B of FIG. 4A;

FIG. 4C is similar to FIG. 4B, but showing that a lens is installed in the lens holder;

FIG. 4D is a schematic partially cutaway perspective view showing the installation relationship between the lens holder of the lens adjusting mechanism having the optic modulating member and the mounting plate;

FIG. 4E is a schematic drawing showing how to control the lens holder equipped with the optic modulating member of the optical inspection device to turn at a specific angle;

FIG. 4F is a schematic partially cutaway perspective view of a lens holder equipped with the optic modulating member of the optical inspection device according to another embodiment of the present invention;

FIG. 4G is a schematic cross-sectional views of a lens holder equipped with the optic modulating member of the optical inspection device according to still another embodiment of the present invention;

FIG. 4H is a schematic perspective view of a lens holder equipped with the optic modulating member of the optical inspection device according to still another embodiment of the present invention;

FIGS. 5A to 5C are schematic cross-sectional views showing that the lens holder equipped with the optic modulating member of the optical inspection device is tightly connected with the circuit board, the mounting plate or the reinforcing plate through a flexible ring;

FIGS. 6A to 6F are schematic cross-sectional views of the optical inspection device according to various embodiments;

FIG. 7 is a schematic cross-sectional view of the optical inspection device according to still another embodiment; and

FIG. 8 is a schematic perspective view showing the way of installing the vertical-cantilever probes.

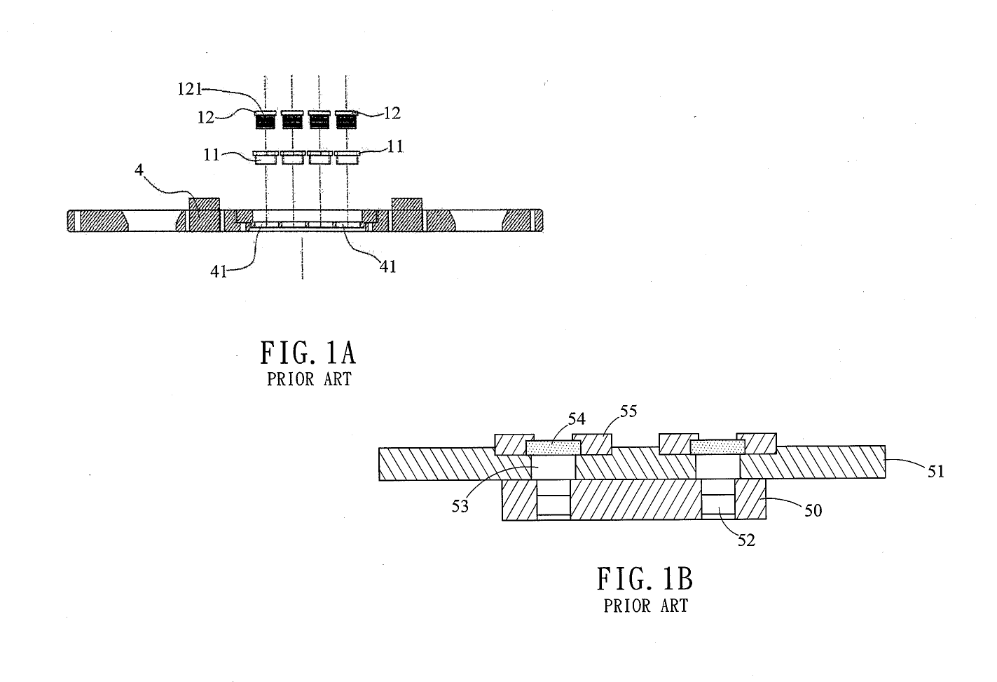

### DETAILED DESCRIPTION OF EMBODIMENTS

It is to be mentioned that the present invention relates to an optical inspection device in the field of probe card, wherein the operational principal and basic function of the probe card are well-known to a person skilled in the art; therefore, the detailed description of the aforesaid operational principal and basic function will not be depicted hereunder for concise illustration purpose. In addition, the accompanying drawings are used to schematically illustrate the structural features of the present invention only; therefore, they are not sketched in accordance with the actual dimension.

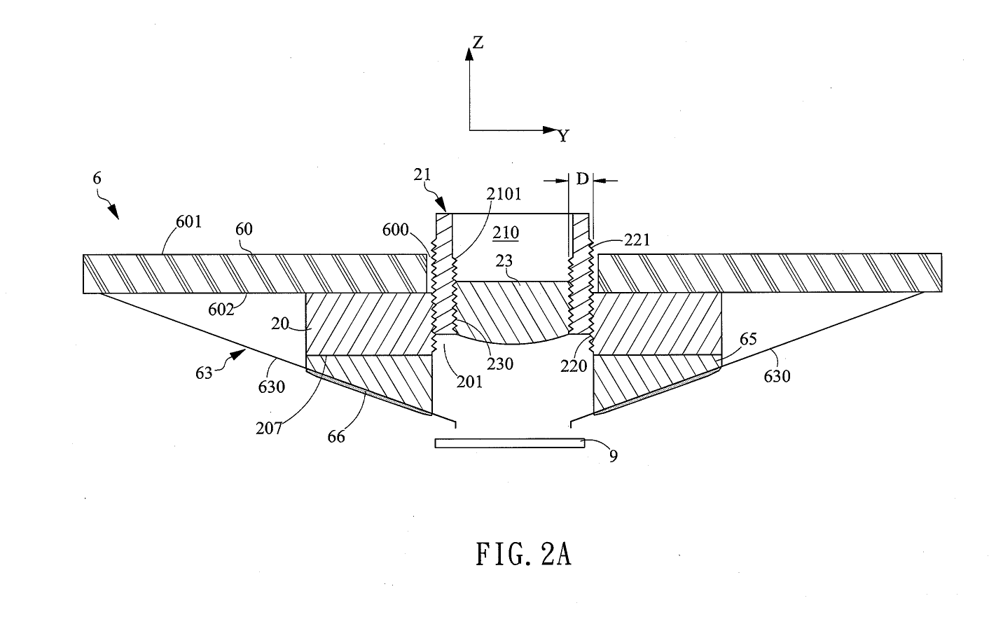

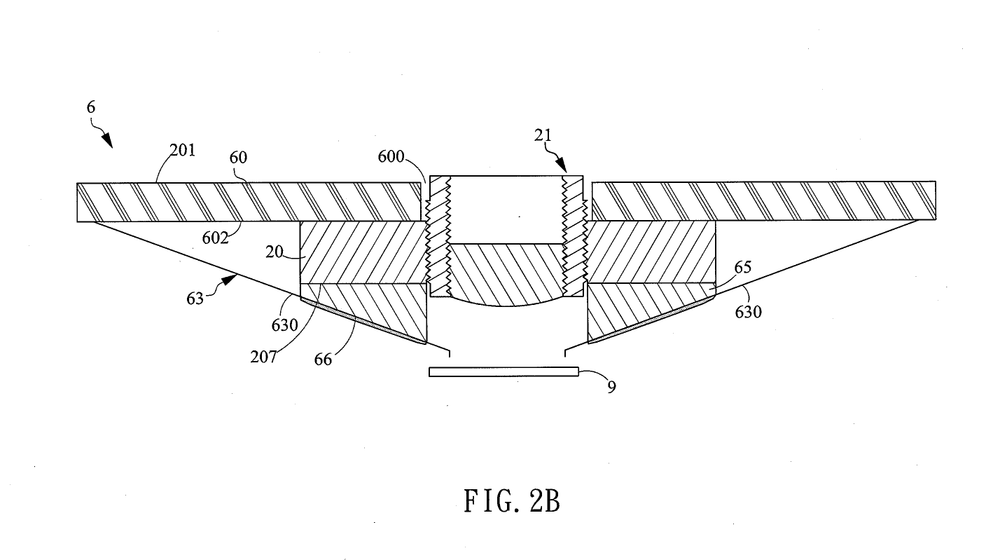

Referring to FIGS. 2A and 2B, these figures are schematic cross-sectional views of an optical inspection device according to an embodiment of the present invention. As shown in these figures, the optical inspection device 6 is composed of a circuit board 60, a mounting plate 20, a lens holder 21 and a probe module 63. The circuit board 60 is provided with contact pads (not shown in the drawings) and at least one first opening 600. The mounting plate 20 is disposed on a bottom surface 602 of the circuit board 60 and provided with at least one second opening 201 corresponding to the at least one first opening 600, and a first thread 220 arranged on the wall surface of the second opening 201. The mounting plate 20 may be made of, but not limited to, engineering plastics, Bakelite or ceramic material. The lens holder 21 is threaded into the second opening 201, and the position of the lens holder 21 inside the second opening 201 can be changed by a position adjusting motion. In this embodiment, the lens holder 21 has, but not limited to, a cylindrical configuration with an accommodation 210. In another embodiment, the lens holder 21 has a thread 2101 formed on the wall surface surrounding the accommodation 210 for being screwingly engaged with the external thread 230 of the lens 23 for positioning the lens 23. By means of the thread engagement of the thread 2101 with the external thread 230, the position of the lens 23 inside the accommodation 210 can be adjusted to provide the selectiveness of adjusting the focus of the lens 23. It is to be understood that the way of mounting the lens 23 is not limited to the thread engagement as disclosed in this embodiment. Any suitable way for mounting the lens 23 inside the accommodation 210 can be adopted by a person skilled in the art according to the actual need.

The probe module 63 is disposed on the bottom surface 207 of the mounting plate 20 or the bottom surface 602 of the circuit board 60 and corresponds in location to the lens holder 21. The probe module 63 includes a plurality of probes 630 electrically connected with the circuit board 60 for probing a device under test (DUT) 9. As shown in FIGS. 2A and 2B, the probe module 63 used in this embodiment belongs to the probe module of a cantilever probe card (CPC); therefore, the probes 630 used in this probe module 63 are cantilever probes. The probe module 63 further comprises a probe holding ring 65 connected with the mounting plate 20, such that the mounting plate 20 is interposed between the circuit board 60 and the probe holding ring 65. The probe holding ring 65 is adapted for holding the probes 630. In order to enhance the holding strength between the probe holding ring 65 and the probes 630, an adhesive 66, such as epoxy resin, can be used for adhering the bodies of the probes 630 to the probe holding ring 65.

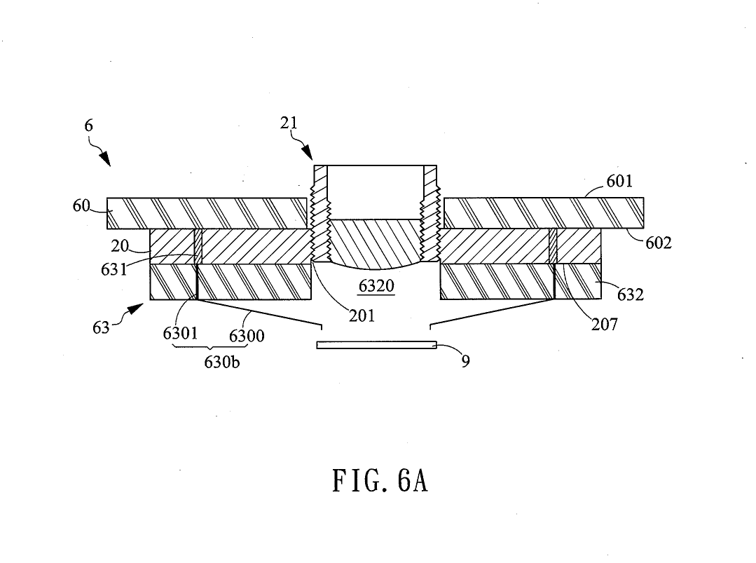

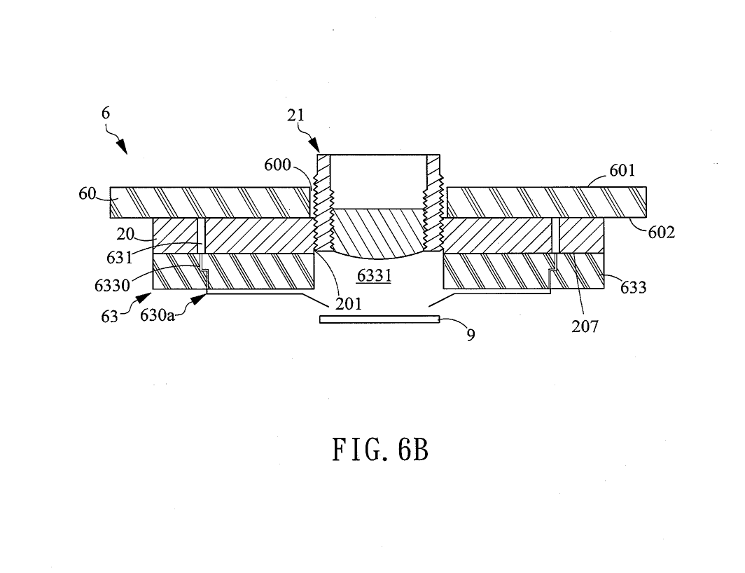

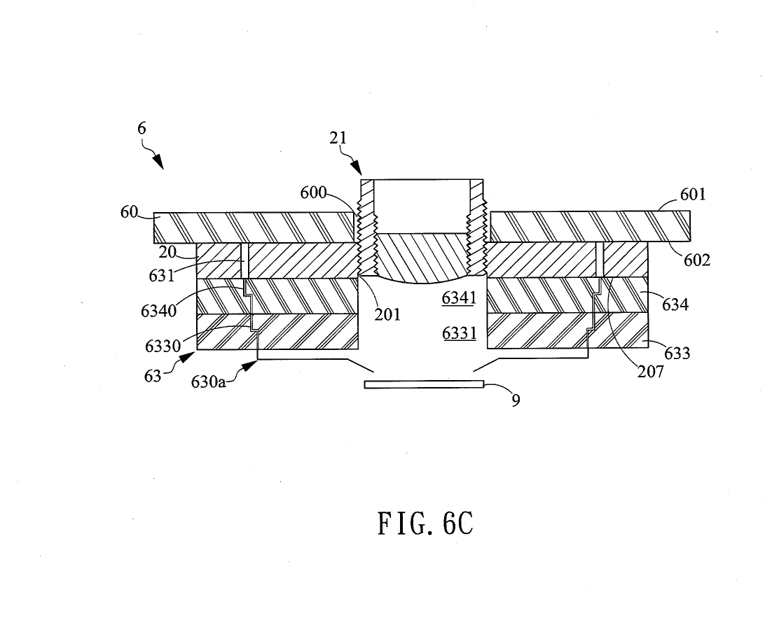

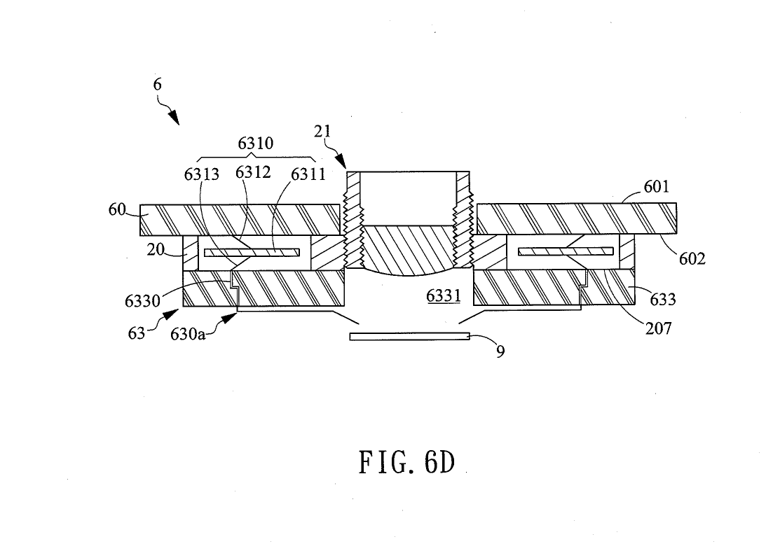

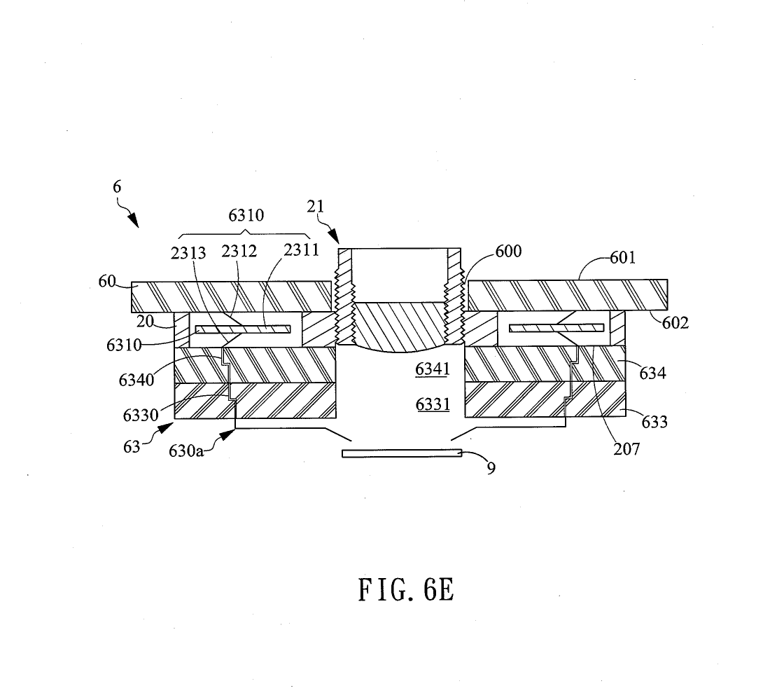

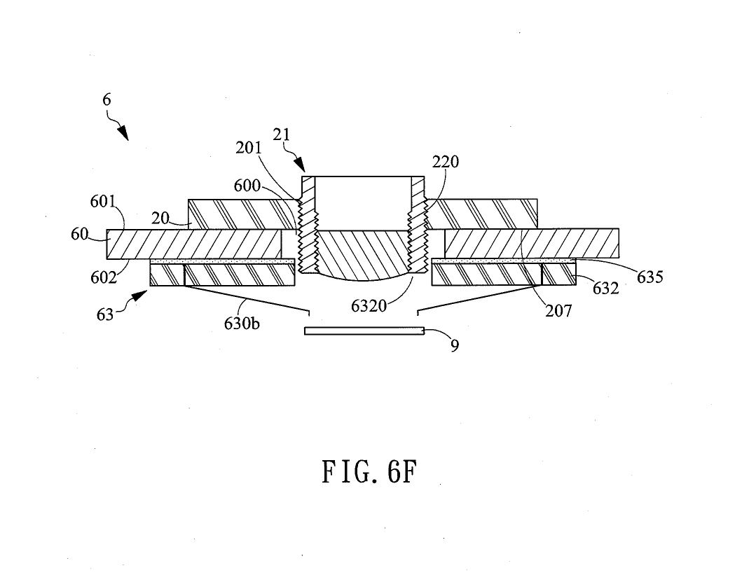

In addition to the optical inspection device 6 shown in FIGS. 2A and 2B, the optical inspection devices of various embodiments will be further depicted in the paragraphs hereunder by reference to FIGS. 6A to 6F.

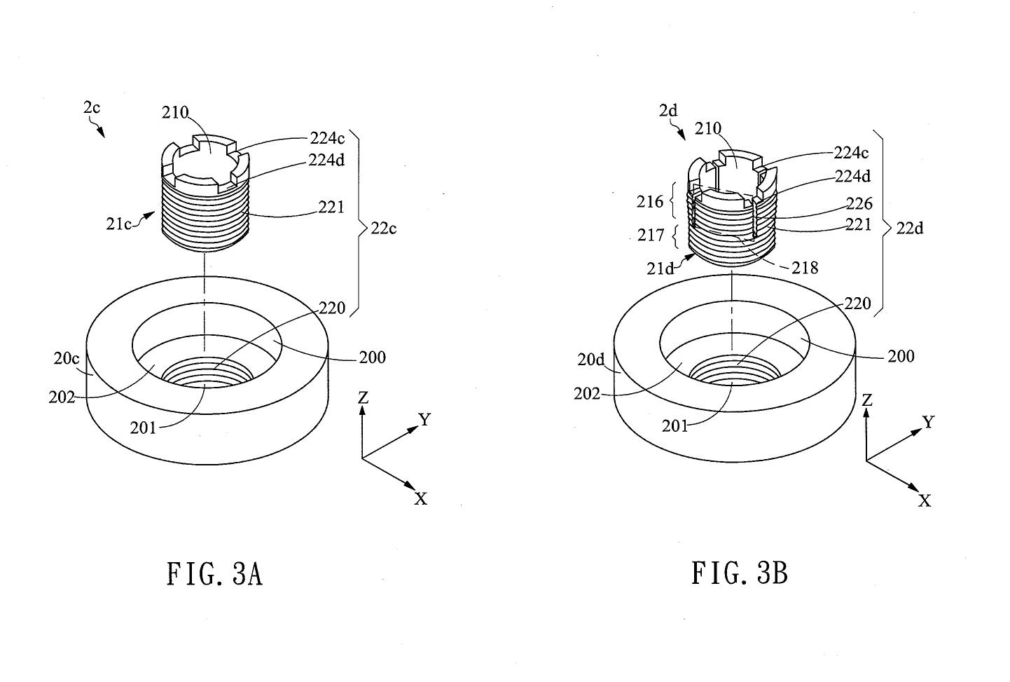

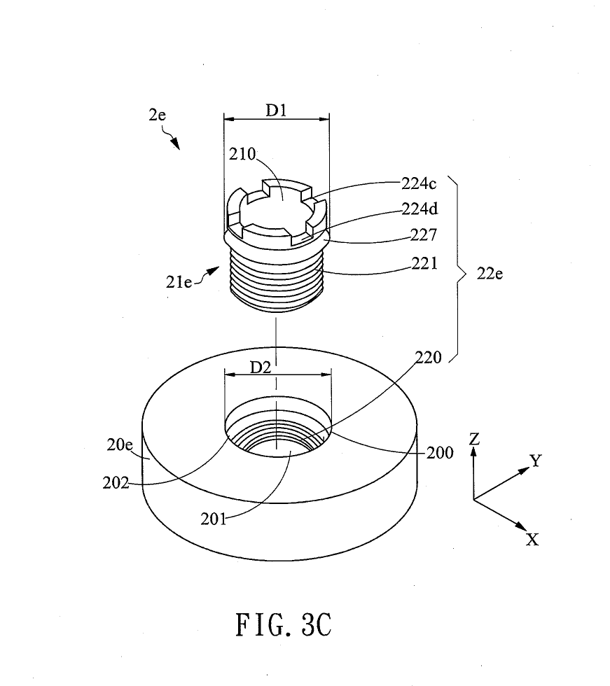

The lens adjusting mechanism of the optical inspection device of the present invention will now be illustrated here. Referring to FIG. 3A, this figure is a schematic perspective view of a lens adjusting mechanism of the optical inspection device according to an embodiment of the present invention. In this embodiment, the lens adjusting mechanism 2c is composed of a mounting plate 20c, a lens holder 21c and a position adjusting structure 22c. The lens holder 21c has a cylindrical configuration in this embodiment; however, the configuration of the lens holder 21c is not limited thereto. In addition, the lens holder 21c is provided with an accommodation 210. The position adjusting structure 22c includes two pairs of adjustment notches 224c and 224d formed on the top surface of the lens holder 21c and symmetrically arranged around the opening of the accommodation 210, a first thread 220 formed on the inner wall surface of the mounting plate 20c surrounding the second opening 201, and a second thread 221 formed on the outer wall surface of the lens holder 21c and screwingly engageable with the first thread 220. In this embodiment, the adverse effect of the backlash between the engaged threads is minimized by increasing the engaging ratio between the first and second threads 220 and 221 or by applying escape-preventing adhesive in between the first thread 220 and the second thread 221 so as to enhance the accuracy of position adjusting motion. In still another embodiment, the engaging ratio of the engaged threads may be increased by using different materials, such as engineering plastics or other metals, to manufacturing the lens holder 21c and the mounting plate 20c. In this embodiment, the lens holder 21c and the mounting plate 20c may be made having different hardness, i.e. the hardness of the mounting plate 20c is greater than that of the lens holder 21c or vice versa, so as to enhance the engaging ratio of the engaged threads. Preferably, the mounting plate 20c is made having a hardness greater than that of the lens holder 21c. In addition, as shown in FIG. 2A, the thickness D defined between the inner wall surface defining the accommodation 210 and the outer wall surface of the lens holder corresponding in location to the accommodation 210 satisfies the equation 0.5 mm≦D≦1.5 mm.

The way of how to adjust the position of the lens holder 21c shown in FIG. 3A is further described hereinafter. Since two pairs of adjustment notches 224c and 224d are provided in this embodiment, the operator can easily control the lens holder 21c to move downward or upward in the Z-axis direction by engaging a cross-shaped jig with the two pairs of the adjustment notches 224c and 224d and then driving the lens holder 21c to turn clockwise or counterclockwise. It is to be understood that the number and the arrangement of the adjustment notches are not limited to the disclosure in this embodiment though there are two pairs of the adjustment notches 224c and 224d shown in this embodiment. For example, at least one engagement notch or one pair of engagement notches may be used for a person skilled in the art based on the design spirit of this embodiment. In the case that one adjustment notch or a pair of adjustment notches are used, the operator can engage a linear-shaped jig with the adjustment notch or the pair of engagement notches and then drive the lens holder 21c to turn. In addition, in another embodiment, the flange 202 of the mounting plate 20c can be eliminated, such that the total volume of the lens adjusting mechanism 2c can be further reduced.

FIG. 3B shows a schematic perspective view of the lens adjusting mechanism of the optical inspection device according to another embodiment of the present invention. In this embodiment, the lens adjusting mechanism 2d comprises a mounting plate 20d, a lens holder 21d and a position adjusting structure 22d. The mounting plate 20d, the lens holder 21d and the position adjusting structure 22d are basically the same as those disclosed in FIG. 3A; however, the difference therebetween lies in that the outer wall surface of the lens holder 21d is divided into a first zone 216 and a second zone 217, and the position adjusting structure 22d further comprises a plurality of slits 226 equiangularly formed at the body of the first zone 216 of the lens holder 21d, such that the first zone 216 of the lens holder 21d is configured having a plurality of engagement adjusting portions 218 expanding inclinedly and outwardly. As a result, the diameter of the first zone 216 having a part of the second thread 221 is gradually decreased from the top to the bottom of the first zone 216; however, the diameter of the second zone 217 having the other part of the second thread 221 maintains constant.

The way of how to adjust the position of the lens holder 21d having two pairs of adjustment notches 224c and 224d shown in FIG. 3B is same as that of the embodiment shown in FIG. 3A; therefore, the detailed description in this matter is not repeatedly illustrated hereunder. In this embodiment, a part of the second thread 221 is distributed on the first zone 216 of the lens holder 21d, the other part of the second thread 221 is distributed on the second zone 217 of the lens holder 21d, and the first zone 216 has a diameter greater than that of the second zone 217; therefore, when the lens holder 21d is screwingly engaged with the mounting plate 20d through the engagement of the second thread 221 on the second zone 217 with the first thread 220 and continuously moves downwards to allow the second thread 221 on the engagement adjusting portions 218, i.e. the first zone 216, to engage with the first thread 220, the outwardly expanded engagement adjusting portions 218 will be restricted and compressed by the second opening 201 of the mounting plate 20d to contract toward inside of the opening of the accommodation 210 of the lens holder 21d as the lens holder 21d continuously moves downward, and meanwhile the slits 226 provide sufficient buffer spaces needed for compression. By means of aforesaid compression action, each engagement adjusting portion 218 produces an outward thrust exerting on the wall of the second opening 201, such that the second thread 221 can be firmly engaged with the first thread 220 to prevent the adverse effect of the backlash between engaged threads as the lens holder 21d moves upwards and downwards, thereby enhancing the accuracy of the position adjusting motion.

FIG. 3C shows a schematic perspective view of the lens adjusting mechanism of the optical inspection device according to still another embodiment of the present invention. In this embodiment, the lens adjusting mechanism 2e comprises a mounting plate 20e, a lens holder 21e and a position adjusting structure 22e. The mounting plate 20e, the lens holder 21e and the position adjusting structure 22e are basically the same as those disclosed in FIG. 3A; however, the difference therebetween lies in that the position adjusting structure 22e further comprises a flexible ring 227, such as but not limited to O-ring, which is sleeved onto the lens holder 21e and located at the topmost portion of the second thread 221. The outer diameter D1 of the flexible ring 227 may be greater than or equal to the caliber D2 of an annular recess 200 of the mounting plate 20e surrounding the second opening 201 of the mounting plate 20e; therefore, when the lens holder 21e is threaded with the mounting plate 20e, the flexible ring 227 will be jammed by the wall of the annular recess 200 to make lens holder 21e and the annular recess 200 be tightly connected with each other, thereby enhancing the securing effect of the lens holder 21e to the mounting plate 20e. In this embodiment, the caliber D2 of the annular recess 200 is greater than the caliber of the second opening 201 as shown in FIG. 3C. In still another embodiment of the present invention, the caliber D2 of the annular recess 200 may be equal to that of the second opening 201 according to the actual need.

The way of how to adjust the position of the lens holder 21e having two pairs of adjustment notches 224c and 224d shown in FIG. 3C is same as that of the embodiment shown in FIG. 3A; therefore, the detailed description in this matter is not repeatedly illustrated hereunder. When the second thread 221 is engaged with the first thread 220 provided on the wall of the second opening 201 and the lens holder 21e is moved downward in Z-axis direction by tuning the lens holder 21e clockwise, the flexible ring 227 will contact and then be squeezed by the wall of the annular recess 200 to deform as the lens holder 21e is continuously moved downward, such that the flexible ring 227 will be tightly connected with the annular recess 200, and the rebound force produced by the compressed flexible ring 227 will exert on the wall of the annular recess 200 to make the lens holder 21e equipped with the flexible ring 227 be more tightly connected with the mounting plate 20e than a lens holder 21e without the flexible ring 227. Under the condition that the flexible ring 227 is tightly connected with the annular recess 200, when the lens holder 21e is moved upwards and downwards, the adverse effect of the backlash between the engaged first and second threads 220 and 221 will be minimized due to the function of the flexible ring 227, thereby reducing the slip of the lens holder 21e during movement of the lens holder 21e. As a result, the position of the lens holder 21e can be precisely controlled when the lens holder 21e is moved upwards and downwards.

It is to be mentioned that in the embodiments shown in FIGS. 3A to 3C, the mounting plate is in cooperation with one lens adjusting mechanism; however, the present invention is not limited to the disclosures shown in these figures. In still another embodiment, the mounting plate may be configured to be equipped with a plurality of lens adjusting mechanisms based on the actual need and the design spirit of the present invention.

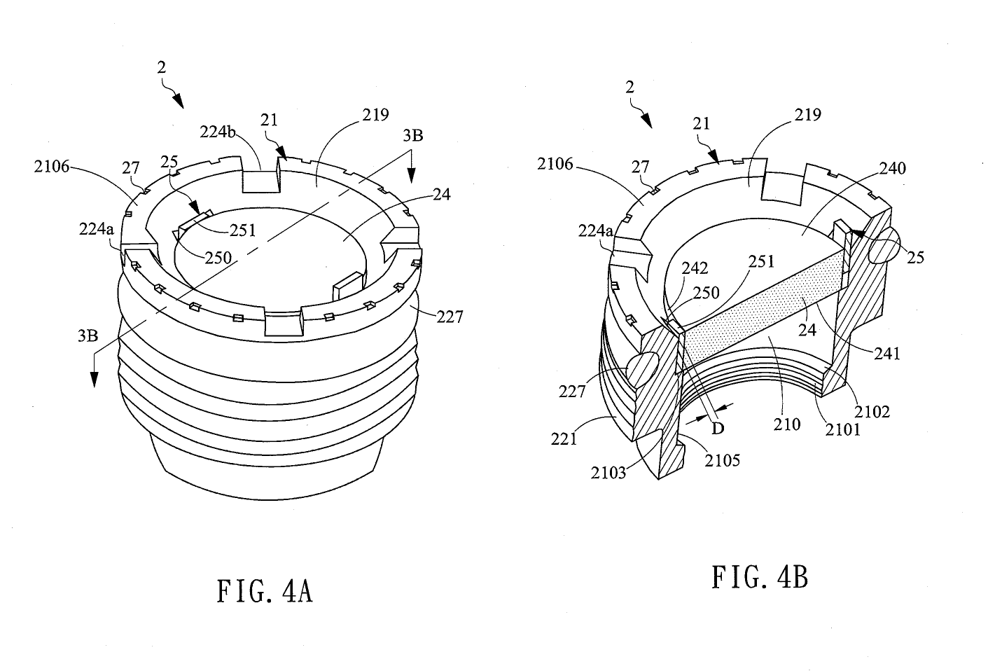

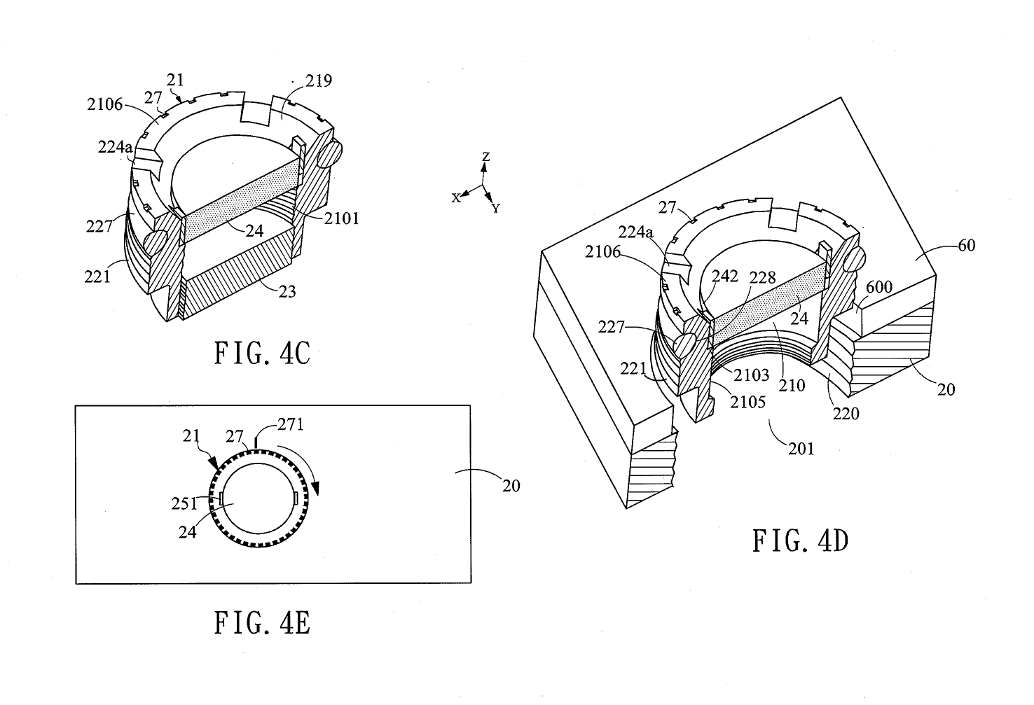

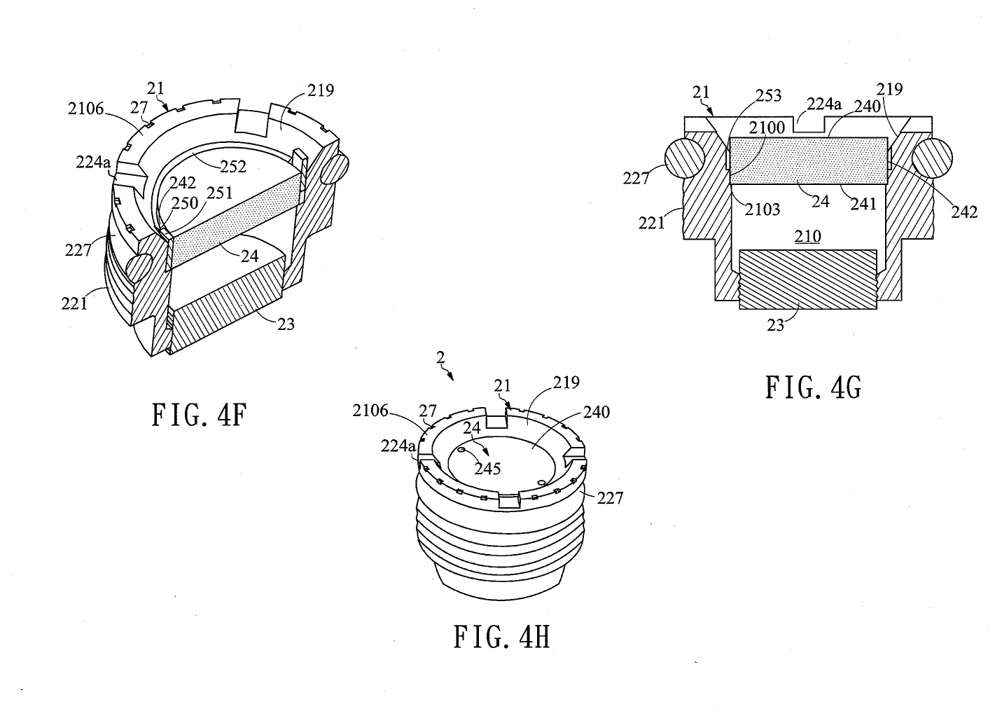

Referring to FIGS. 4A and 4B, FIG. 4A is a schematic perspective view of a lens adjusting mechanism having an optic modulating member of the optical inspection device according to an embodiment of the present invention, and FIG. 4B is a cross-sectional view taken along the line 4B-4B of FIG. 4A. The lens adjusting mechanism in this embodiment has a structure basically same as that of the above-disclosed lens adjusting mechanism but with a difference lying in that the lens adjusting mechanism is provided with an optic modulating member and a fixing structure for holding the optic modulating member for evenly diffusing light or filtering light so as to enhance the effect of optical inspection. Specifically speaking, the lens adjusting mechanism 2 is composed of a lens holder 21, an optic modulating member 24 and a fixing structure 25. In this embodiment, the lens holder 21 has, but not limited to, a cylindrical configuration with an accommodation 210. The lens holder 21 is provided with a first protrusion 2103 protruding from the wall surface 2105 of the accommodation 210, an annular protrusion 2102 at a bottom side of the wall surface 2105 of the accommodation 210 opposite to the optic modulating member 24, and a thread 2101 on the wall surface of the annular protrusion 2102 facing the accommodation 210. It is to be mentioned that the annular protrusion 2102 in this embodiment can be eliminated, and in this case the thread 2101 can be formed on the wall surface 2105 of the accommodation 210 as shown in FIG. 4C.

As shown in FIGS. 4A and 4B, the optic modulating member 24 is received in the accommodation 210 and has a top surface 240, a bottom surface 241 and a lateral side 242 annularly connected between the top and bottom surfaces 240 and 241. The optic modulating member 24 may be, but not limited to, a diffuser for evenly diffusing light, a filter for filtering light, or a combination thereof for enhancing the effect of optical inspection.

In this embodiment, the bottom surface 241 of the optic modulating member 24 is supported on the first protrusion 2103, and the optic modulating member 24 is detachably received in the accommodation 210 by the fixing structure 25 which includes at least one fixing notch 250 and at least one inserter 251. Preferably, the fixing structure 25 includes a pair of fixing notches 250 and a pair of inserters 251 in this embodiment. The pair of fixing notches 250 are formed on the wall surface of the accommodation 210 adjacent to the top surface 2106 of the lens holder 21 and correspond to the lateral side 242 of the optic modulating member 24. The pair of the inserters 251 are respectively inserted into the fixing notches 250 for securing the optic modulating member 24 in position. Each inserter 251 has a thickness greater than the distance D defined between the lateral side 242 of the optic modulating member 24 and the wall surface of the fixing notch 250 facing the lateral side 242 of the optic modulating member 24; therefore, when the inserter 251 is inserted into the corresponding fixing notch 250, a lateral reaction force may generate and exert on the optic modulating member 24 so as to secure the optic modulating member 24 in position. In another embodiment, the inerter 251 is made of a material that expands when it is heated up and contracts upon cooling down, such that the inserter 251 having a small volume at a lower temperature may be inserted into the fixing notch 250 and then jammed between the wall of the notch 250 and the optic modulating member 24 to secure the optic modulating member 24 position when the inserter 251 returns back to its original volume at room temperature. In addition, the inserter may be made of a heat-contraction and cold-expansion material or shape memory material. It is to be mentioned again that a pair of fixing notches 250 and a pair of inserters 251 are used in this embodiment, but the present invention is not limited thereto. For example, a combination of a single fixing notch 250 and a single inserter 251 can be used.

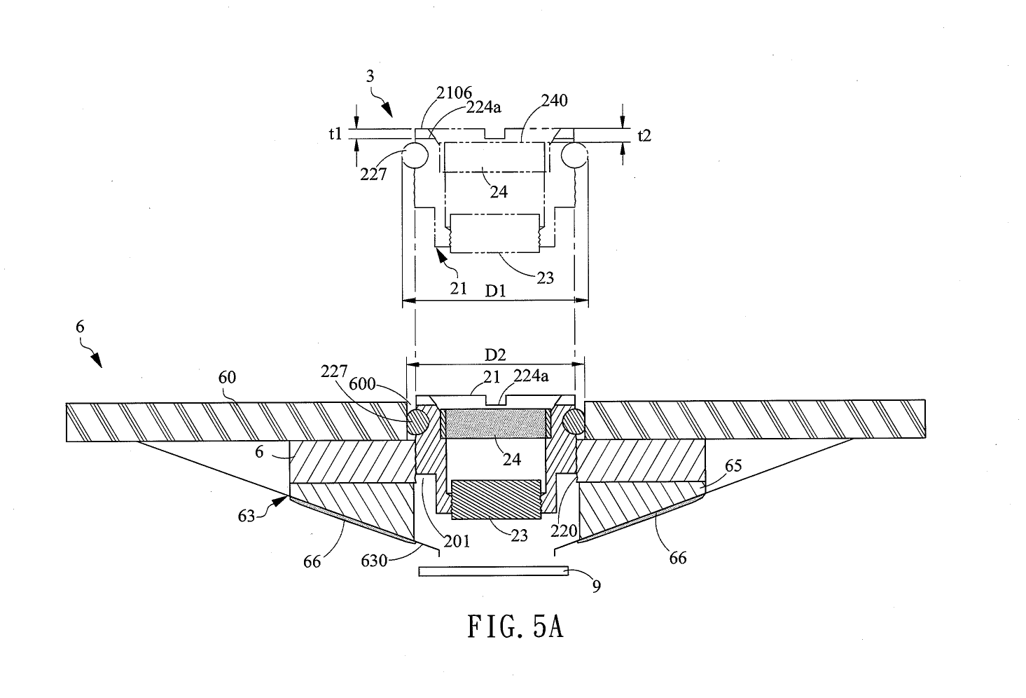

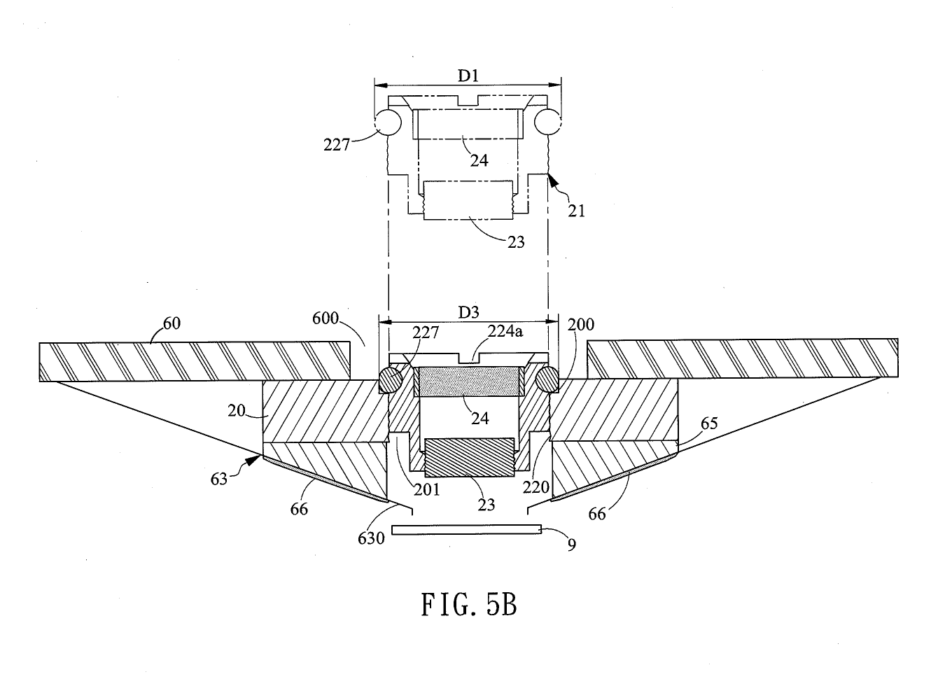

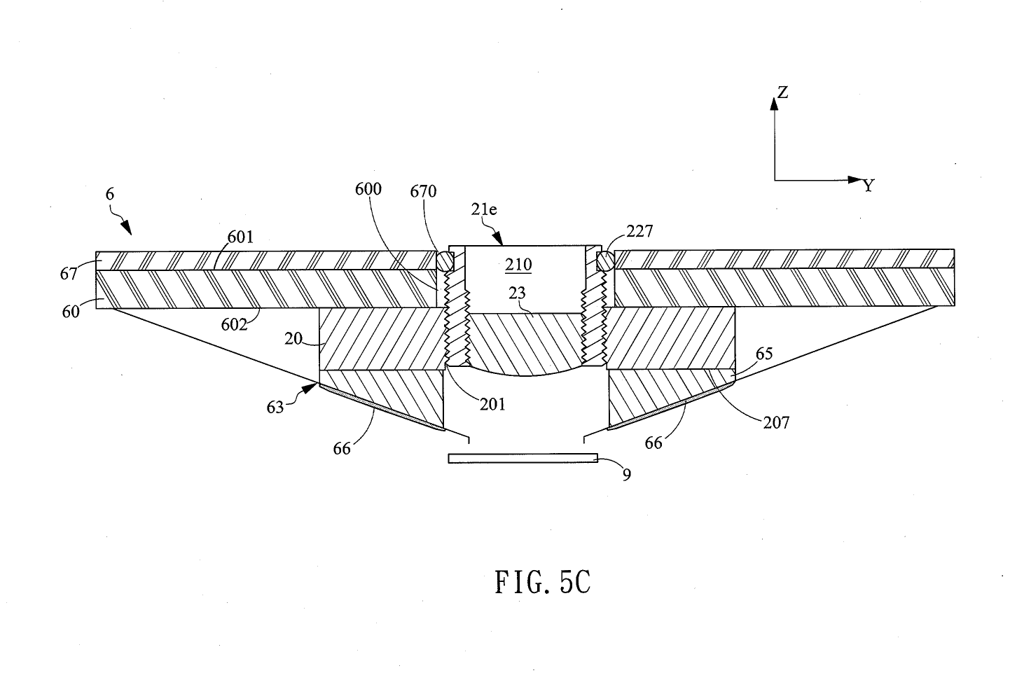

In this embodiment, the lens holder 21 has a beveled surface 219 inclined from the top surface 2106 towards an inside of the accommodation 210 to widen the opening area of the lens holder 21 to facilitate collection of light. Referring to FIG. 5A as well as FIGS. 4A and 4 B, for preventing the surface of the optic modulating member 24 from damage during adjustment of the vertical position of the lens holder 21, the depth t1 of the adjustment notch 224a, i.e. the distance from the top surface 2106 of the lens holder 21 to the bottom surface of the adjustment notch 224a, is designed to be smaller than the distance t2 defined from the top surface 2106 of the lens holder 21 to the top surface 240 of the optic modulating member 24, i.e. t2>t1 in this embodiment. In this way, a certain distance will be left between the adjustment notch 224a and the optic modulating member 24 to prevent the optic modulating member 24 from damage during the position adjusting motion of the lens holder 21.

Referring to FIG. 4A again, the lens holder 21 is provided at the top surface 2106 thereof with two pairs of adjustment notches 224a and 224b which are symmetrically arranged on the top surface 2106. Because two pairs of adjustment notches 224a and 224b are provided in this embodiment, the operator can easily control the lens holder 21 to move downward or upward in the Z-axis direction by engaging a cross-shaped jig with the two pairs of the adjustment notches 224a and 224b and then driving the lens holder 21 to turn clockwise or counterclockwise. It is to be understood that the number and the arrangement of the adjustment notches are not limited to the disclosure in this embodiment though there are two pairs of the adjustment notches 224a and 224b shown in this embodiment. For example, in another embodiment, the lens holder may have a pair of adjustment notched, and in this case the operator can engage a linear-shaped jig with the pair of engagement notches and then drive the lens holder to turn. In addition, odd numbers of engagement notches or at least one engagement notch may be used for a person skilled in the art based on the design spirit of this embodiment.

FIG. 4C is a schematic cross-sectional view of the lens adjusting mechanism having an optic modulating member according to another embodiment of the present invention, showing that a lens 23 is screwingly engaged with the thread 2101. By means of the thread engagement, the lens 23 can be received and fixed inside the accommodation 210.

FIG. 4D is a schematic partially cutaway perspective view showing the installation relationship between the lens holder of the lens adjusting mechanism having the optic modulating member and the mounting plate. The mounting plate 20 has at least one second opening 201 and a thread 220 provided at the wall surface surrounding the second opening 201. On the top surface of the mounting plate 20 a circuit board 60 is provided. The circuit board 60 has at least one first opening 600 corresponding to the at least one second opening 201. Referring to FIGS. 4C and 4D, by means of the engagement of the second thread 221 on the outer periphery of the lens holder 21 with the first thread 220, the position of the lens holder 21 can be adjusted to further adjust the position of the focus of the lens 23 in Z-axis direction. The lens holder 21 is further provided at the outer wall surface thereof with an annular recess 228 in which a flexible ring 227 is received, such that the flexible ring 227 is disposed surrounding around the outer periphery of the lens holder 21 in this embodiment.

Referring to FIG. 5A again, the outer diameter D1 of the flexible ring 227 may be greater than or equal to the diameter D2 of the first opening 600; therefore, when the lens holder 21 is threaded with the mounting plate 20, the flexible ring 227 will be jammed by the wall of the first opening 600, and at the meantime the rebound force produced by the compressed flexible ring 227 will exert on the wall of the first opening 600 to make the lens holder 21 equipped with the flexible ring 227 be more tightly connected with wall of the first opening 600 than a lens holder without the flexible ring 227 so as to enhance the securing effect of the lens holder 21 to the circuit board 60. Under the condition that the flexible ring 227 is tightly connected with the first opening 600, when the lens holder 21 is moved upwards and downwards, the adverse effect of the backlash between the engaged threads of the lens holder 21 and the mounting plate 20 will be minimized due to the function of the flexible ring 227. As a result, the position of the lens holder 21 can be precisely controlled when the lens holder 21 is moved upwards and downwards.

As shown in FIG. 5B, in this embodiment, on a periphery of the second opening 201 of the mounting plate 20 an annular recess 200 is formed. The outer diameter D1 of the flexible ring 227 may be greater than or equal to the caliber D3 of the corresponding recess 200; therefore, when the lens holder 21 is threaded with the mounting plate 20, the flexible ring 227 will be jammed by the wall of the annular recess 200 to make the lens holder 21 and the annular recess 200 be tightly connected with each other and make the lens holder 21 equipped with the flexible ring 227 be more tightly connected with wall of the annular recess 200 than a lens holder without the flexible ring 227 so as to enhance the securing effect of the lens holder 21 to the mounting plate 20.

As shown in FIG. 5C, a reinforcing plate 67 is mounted on the circuit board 60 and provided with an opening 670 corresponding to the first opening 600 and the threaded second opening 201. The reinforcing plate 67 is configured having a certain stiffness. In this embodiment, the outer diameter of the flexible ring 227 may be greater than or equal to the diameter of the opening 670 of the reinforcing plate 67; therefore, when the lens holder 21e is threaded with the mounting plate 20 and moved downwards, the flexible ring 227 will be jammed by and tightly connected with the wall of the opening 670 to have a securing effect. It is to be mentioned that the slip of the lens holder can be minimized by the flexible ring provided at the lens holder.

Referring to FIG. 4E, this figure is a schematic top view showing how to control the lens holder having an optic modulating member of the optical inspection device to turn at a specific angle according to an embodiment. In this embodiment, the lens holder 21 is provided at the top surface 2106 thereof with at least one scale 27 and the mounting plate 20 is provided with at least one pointer 271. When the lens holder 21 is screwingly engaged with the mounting plate 20, the elevation of the lens holder 21 in the Z-axis direction can be determined from the relationship between the scale 27 and the pointer 271, which indicates the angle that the lens holder 21 has been turned. In another embodiment, the scale 27 may be formed on the mounting plate 20 and the pointer 271 may be formed on the top surface 2106 of the lens holder 21.

FIG. 4F is a schematic partially cutaway perspective view of a lens holder having an optic modulating member of the optical inspection device according to another embodiment of the present invention. The lens holder in this embodiment is basically similar to the lens holder shown in FIG. 4B but has a difference lying in that the inserter 251 is made of a magnetism attractable metal and a magnet 252 is disposed at two sides of each fixing notch 250 and located between the lateral side 242 of the optic modulating member 24 and the wall surface of the accommodation 210. Referring to FIG. 4G, this figure is a schematic cross-sectional view of a lens holder with an optic modulating member of the optical inspection device according to still another embodiment of the present invention. In this embodiment, the lateral side 242 of the optic modulating member 24 is tightly fitted into the accommodation 210. At least one tool receiving notch 253 is provided on the wall 2100 of the accommodation 210 corresponding to the lateral side 242 of the optic modulating member 24. When the optic modulating member 24 is tightly fitted with the wall 2100 of the accommodation 210 and needs to be detached from the lens holder 21, an operator can insert a clamping tool deep into the tool receiving notch 253 and pick the optic modulating member 24 up and then take the optic modulating member 24 out of the lens holder 21 by the clamping tool. In the case that a pair of tool receiving notches are provided, the optic modulating member 24 can be clamped out of the lens holder 21 by using a clamping tool in cooperation with the pair of tool receiving notches 253. In other words, the number and arrangement of the tool receiving notch may be designed based on the actual need.

FIG. 4H is a schematic perspective view of a lens holder with an optic modulating member of the optical inspection device according to still another embodiment of the present invention. In this embodiment, the optic modulating member 24 has at least one through hole 245 adjacent to the wall 2100 of the accommodation 210. The through hole 245 has an opening on the top surface 240 of the optic modulating member 24, such that the through hole 245 may serve as a tool receptacle for allowing the optic modulating member 24 to be taken out of the lens holder 21 by a clamping tool as mentioned above. In addition to the tight fitting method for fixing the optic modulating member 24 to the lens holder 21, in another embodiment the space defined between the lens 23 threaded with the wall of the accommodation 210 and the optic modulating member 24 is maintained at a reduced pressure for fixing the optic modulating member 24 to the lens holder 21. As to how to take the optic modulating member out of the lens holder under a reduced pressure condition, please refer to the way of adopting the tool receiving notch or the through hole 245 mentioned above.

The embodiments of the optical inspection device 6 of the present invention will be depicted hereinafter. Referring to FIG. 6A, this figure shows the optical inspection device 6 according to another embodiment. In this embodiment, the mounting plate 20 is disposed on the bottom surface 602 of the circuit board 60 and provided with a plurality of pogo pins 631. The probe module 63 is disposed on the bottom surface 207 of the mounting plate 20 and provided with a plurality of vertical-cantilever probes 630b and a probe holder 632. The pogo pins 631 are arranged inside the body of the mounting plate 20 and correspond to the vertical-cantilever probe 630b. Each pogo pin 631 is electrically connected with a contact pad of the circuit board 60. In another embodiment, the pogo pin 631 is covered at a periphery thereof with an insulated material. The probe holder 632 is connected with the mounting plate 20, such that the mounting plate 20 is interposed between the circuit board 60 and the probe holder 632. The probe holder 632 is adapted for holding the vertical-cantilever probes 630b and has a third opening 6320 corresponding to the second opening 201. Each vertical-cantilever probe 630b has a section penetrating through the probe holder 632 and being electrically connected with the corresponding pogo pin 631, such that the vertical-cantilever probe 630b is electrically connected with the corresponding contact pad of the circuit board 60 through the corresponding pogo pin 631. In this embodiment, the vertical-cantilever probe is configured having a suspension arm 6300 and a vertical section 6301 which penetrates through the probe holder 632 and is electrically connected with the pogo pin 631.

Referring to FIG. 6B, this figure shows the optical inspection device 6 according to still another embodiment. In this embodiment, the mounting plate 20 is disposed on the bottom surface 602 of the circuit board 60 and provided with a plurality of pogo pins 631. The pogo pins 631 are arranged inside the body of the mounting plate 20 and electrically connected with the circuit board 60. In another embodiment, the pogo pin 631 is covered at a periphery thereof with an insulated material. The probe module 63 is disposed on the bottom surface 207 of the mounting plate 20 and provided with a plurality of micro electro-mechanical system (MEMS) probes 630b and a probe substrate 633 connected with the mounting plate 20, such that the mounting plate 20 is interposed between the circuit board 60 and the probe substrate 633. The probe substrate 633 has a fourth opening 6331 corresponding to the second opening 201 and the first opening 600, and a plurality of first internal circuits 6330 formed inside the body thereof. The MEMS probes 630a are formed on the probe substrate 633 and electrically connected with the corresponding pogo pins 631 through the corresponding first internal circuits 6330, such that the MEMS probes 630a are electrically connected with the corresponding contact pads of the circuit board 60. It is to be mentioned that the MEMS probes 630a are directly formed on the probe substrate 633 by MEMS manufacturing process, which is a well-known prior art and needs not to be illustrated hereunder.

FIG. 6C shows the optical inspection device 6 according to still another embodiment, which is basically similar in construction to the optical inspection device 6 disclosed in FIG. 6B but has a difference lying in that a space transforming plate 634 is further included. The space transforming plate 634 is disposed between the mounting plate 20 and the probe substrate 633 and provided with a fifth opening 6341 corresponding to the fourth opening 6331, the second opening 201 and the first opening 600. The space transforming plate 634 is provided at an inside of the body thereof with a plurality of second internal circuits 6340 electrically connected with the pogo pins 631, the first internal circuits 6330 and the MEMS probes 630a. The space transforming plate 634 is a so-called space transformer playing a role of space transforming. That is, the electric contacts on the top surface of the space transformer are corresponding to and electrically connected with the electric contacts on the bottom surface of the space transformer; however, the locations and density of distribution of the electric contacts on the top surface are different from those on the bottom surface, such that a relatively greater pitch of the electric contacts on a surface is transformed into a relatively smaller pitch of the electric contacts on the other surface, or vase versa. The locations and density of distribution of the electric contacts of the space transforming plate 634 are determined based on the kind of device under test (DUT) 9 and requirements, which are not specifically limited.

FIG. 6D shows the optical inspection device 6 according to still another embodiment, which is basically similar in construction to the optical inspection device 6 disclosed in FIG. 6B but has a difference lying in that the pogo pins 631 of FIG. 6B are replaced by interposers 6310. The interposer 6310 includes an interposing substrate 6311, and first resilient interconnection elements 6312 and second resilient interconnection elements 6313 mounted to the interposing substrate 6311 and respectively and electrically connected with each other one by one. In this embodiment, the mounting plate 20 is disposed on the bottom surface 602 of the circuit board 60. The top surface of the interposing substrate 6311 is electrically connected with the circuit board 60 through the first resilient interconnection elements 6312, and the bottom surface of the interposing substrate 6311 is electrically connected with the first internal circuits 6330 and the MEMS probes 630a through the second resilient interconnection elements 6313. In addition, as shown in FIG. 6E, the optical inspection device 6 in this embodiment further comprises a space transforming plate 634 compared with the optical inspection device shown in FIG. 6D. The space transforming plate 634 is disposed between the mounting plate 20 and the probe substrate 633 and provided with a fifth opening 6341 corresponding to the fourth opening 6331, the second opening 201 and the first opening 600. The space transforming plate 634 is provided at an inside of the body thereof with a plurality of second internal circuits 6340 electrically connected with the second resilient interconnection elements 6313, the first internal circuits 6330 and the MEMS probes 630a.

Referring to FIG. 6F, this figure shows the optical inspection device 6 according to still another embodiment. In this embodiment, optical inspection device 6 comprises a circuit board 60, a mounting plate 20, a lens holder 21 and a lens module 63. The circuit board 60 has contact pads (not shown in the drawing) and a first opening 600. The mounting plate 20 is disposed on the top surface 601 of the circuit board 60 and provided with a second opening 201 corresponding to the first opening 600. The mounting plate 20 may be made of, but not limited to, engineering plastics, Bakelite or ceramic material. The lens holder 21 is threaded into the second opening 201, and the position of the lens holder 21 inside the second opening 201 can be changed by a position adjusting motion. The probe module 63 is disposed on the bottom surface 602 of the circuit board 60. The probe module 63 includes a plurality of vertical-cantilever probe 630b, and a probe holder 632 disposed on the bottom surface 602 of the circuit board 60. The probe holder 632 is adapted for holding the vertical-cantilever probes 630b and has a third opening 6320 corresponding to the second opening 201. In addition, the optical inspection device 6 further comprises an electrically conductive layer 635 formed between the probe holder 632 and the circuit board 60 and electrically connected with the vertical-cantilever probes 630b and the circuit board 60. It is to be specifically mentioned that the electrically conductive layer 635 may be, but not limited to, an anisotropic conductive film (ACF), the interposer 504 disclosed in U.S. Pat. No. 6,741,085, the spring member disclosed in US20050174132 A1, or the spring connectors 214 disclosed in US20120169367 A1.

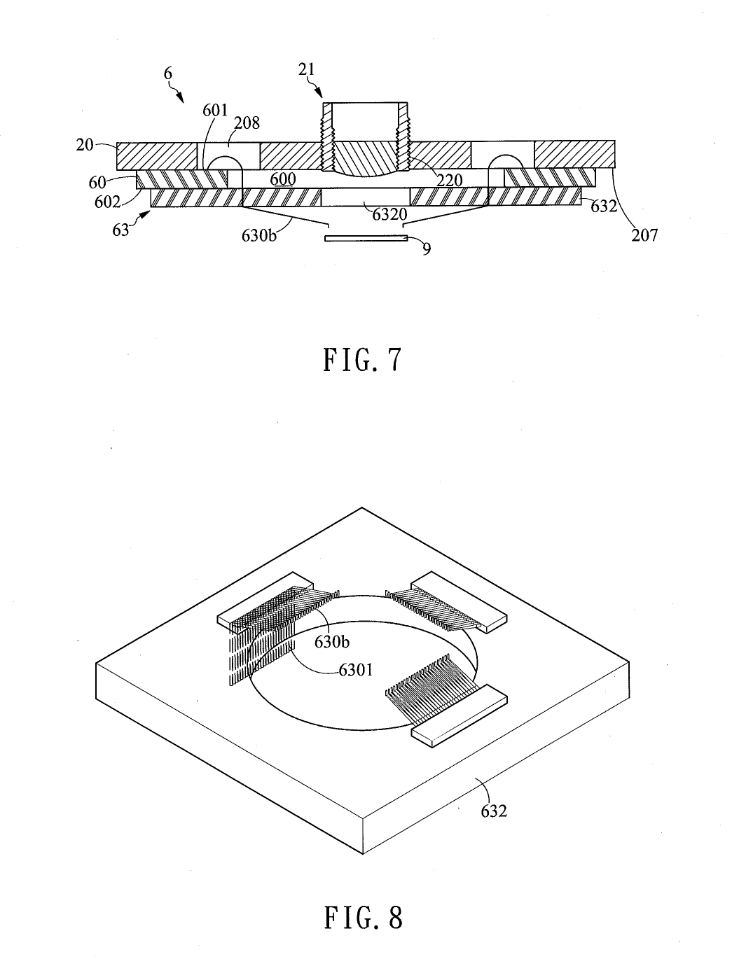

Referring to FIG. 7, this figure shows the optical inspection device 6 according to still another embodiment. In this embodiment, optical inspection device 6 comprises a circuit board 60, a mounting plate 20, a lens holder 21 and a lens module 63. The circuit board 60 has contact pads (not shown in the drawing) and a first opening 600. The mounting plate 20 is disposed on the top surface 601 of the circuit board 60 and provided with a second opening 201 corresponding to the first opening 600. The lens holder 21 is threaded into the second opening 201, and the position of the lens holder 21 inside the second opening 201 can be changed by a position adjusting motion. The probe module 63 is disposed on the bottom surface 602 of the circuit board 60 and provided with a plurality of vertical-cantilever probe 630b and a probe holder 632 disposed on the bottom surface 602 of the circuit board 60 for holding the vertical-cantilever probes 630b. The probe holder 632 has a third opening 6320 corresponding to the second opening 201.

In this embodiment, the diameter of the first opening 600 is greater than the diameter of the second opening 201 and the diameter of the third opening 6320. The mounting plate 20 is further provided with a sixth opening 208 corresponding to the first opening 600. Each vertical-cantilever probe 630b has a section penetrating through the probe holder 632, passing through the first opening 600 and the sixth opening 208 and being electrically connected with the contact pad on the top surface 601 of the circuit board 60.

Referring to FIG. 8, this figure is a schematic perspective drawing showing the arrangement of the vertical-cantilever probes 630b of FIG. 7. The probe holder 632 is arranged with a plurality of vertical-cantilever probes 630b in an N-type probe arrangement, i.e. each probe 630b has a vertical section 6301 set in a posture substantially perpendicular to the probe holder 632.

It is to be further mentioned that the lens holders disclosed in FIGS. 3A to 3C and FIGS. 4A to 4H can be adopted in the optical inspection devices disclosed in FIGS. 2A and 2B, FIGS. 5A to 5C and FIGS. 6A to 6F.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An optical inspection device comprising:
a circuit board having at least one first opening;
at least one lens adjusting mechanism comprising:
a mounting plate disposed on a top surface or a bottom surface of the circuit board and provided with at least one second opening corresponding to the at least one first opening respectively; and
at least one lens holder received in the at least one second opening and each provided with an accommodation for accommodating a lens, wherein a position of the at least one lens holder in the at least one second opening is adjustable by a position adjusting motion; and
at least one probe module disposed on a bottom surface of the mounting plate or the bottom surface of the circuit board, corresponding to the at least one lens holder respectively, and each provided with a plurality of probes electrically connected with the circuit board.

2. The optical inspection device as claimed in claim 1, further comprising a flexible ring sleeved onto the at least one lens holder.

3. The optical inspection device as claimed in claim 2, wherein the at least one lens holder is provided with an annular recess into which the flexible ring is sleeved.

4. The optical inspection device as claimed in claim 1, wherein the at least one lens holder has a top surface on which at least one adjustment notch is provided.

5. The optical inspection device as claimed in claim 1, wherein the mounting plate is disposed on the bottom surface of the circuit board; wherein the optical inspection device further comprises:
a first thread formed on a wall surface of the at least one second opening; and
a second thread formed on an outer wall surface of the at least one lens holder for engaging with the first thread.

6. The optical inspection device as claimed in claim 1, wherein the mounting plate is disposed on the top surface of the circuit board; wherein the optical inspection device further comprises:
a first thread formed on a wall surface of the at least one second opening; and
a second thread formed on an outer wall surface of the at least one lens holder for engaging with the first thread.

7. The optical inspection device as claimed in claim 1, further comprising a flexible ring sleeved onto the lens holder; wherein the mounting plate has an annular recess surrounding a periphery of the second opening; an outer diameter of the flexible ring is greater than or equal to a caliber of the annular recess.

8. The optical inspection device as claimed in claim 1, further comprising a flexible ring sleeved onto the lens holder and having an outer diameter greater than or equal to a diameter of the first opening.

9. The optical inspection device as claimed in claim 1, further comprising a reinforcing plate disposed on the top surface of the circuit board and provided with an opening corresponding to the at least one second opening and the at least one first opening, and a flexible ring sleeved on the at least one lens holder and having an outer diameter greater than or equal to a diameter of the opening of the reinforcing plate.

10. The optical inspection device as claimed in claim 1, wherein the at least one lens holder has a beveled surface inclined from a top surface of the at least lens holder towards an inside of the accommodation for increasing an opening area of the at least one lens holder.

11. The optical inspection device as claimed in claim 1, wherein the at least one lens holder has a top surface on which at least one pointer or at least one scale is provided.

12. The optical inspection device as claimed in claim 1, further comprising at least one optic modulating member detachably disposed in the accommodation by a fixing structure.

13. The optical inspection device as claimed in claim 12, wherein a wall surface of the accommodation is provided with a first protrusion for supporting the at least one optic modulating member.

14. The optical inspection device as claimed in claim 13, wherein the at least one optic modulating member has a top surface, a bottom surface supported on the first protrusion, and a lateral side annularly connected with the top and bottom surfaces.

15. The optical inspection device as claimed in claim 14, wherein the lateral side of the at least one optic modulating member is tightly fitted with the wall surface of the accommodation.

16. The optical inspection device as claimed in claim 15, wherein the wall surface of the accommodation is provided with at least one tool receiving notch corresponding to the lateral side of the at least one optic modulating member.

17. The optical inspection device as claimed in claim 14, wherein the fixing structure comprises:
at least one fixing notch formed on the wall surface of the accommodation and corresponding to the lateral side of the at least one optic modulating member; and
at least one inserter inserted into the at least one fixing notch respectively for securing the at least one optic modulating member.

18. The optical inspection device as claimed in claim 17, wherein the at least one inserter has a thickness greater than or equal to a distance defined between the lateral side of the at least one optic modulating member and a wall surface of the at least one fixing notch facing the lateral side of the at least one optic modulating member.

19. The optical inspection device as claimed in claim 17, wherein the at least one inserter is made of a magnetism attractable metal and a magnet is disposed at two sides of each said fixing notch and located between the lateral side of the at least one optic modulating member and the wall surface of the accommodation.

20. The optical inspection device as claimed in claim 12, wherein the at least one lens holder has a top surface on which at least one adjustment notch is provided; wherein the at least one adjustment notch has a depth smaller than a distance defined from the top surface of the at least one lens holder to a top surface of the at least one optic modulating member.

21. The optical inspection device as claimed in claim 1, wherein the mounting plate is disposed on the bottom surface of the circuit board and provided with a plurality of pogo pins arranged inside a body of the mounting plate; wherein the probe module is disposed on the bottom surface of the mounting plate and provided with the probes that are vertical-cantilever probes, and a probe holder for holding the vertical-cantilever probes; wherein the probe holder is connected with the mounting plate in a way that the mounting plate is interposed between the circuit board and the probe holder; the probe holder is provided with a third opening corresponding to the at least one second opening; wherein the pogo pins are electrically connected with the vertical-cantilever probes and the circuit board.

22. The optical inspection device as claimed in claim 1, wherein the mounting plate is disposed on the bottom surface of the circuit board and provided with a plurality of pogo pins arranged inside a body of the mounting plate; wherein the probe module is disposed on the bottom surface of the mounting plate and comprises:
a probe substrate connected with the mounting plate in a way that the mounting plate is interposed between the circuit board and the probe substrate; the probe substrate being provided with a fourth opening corresponding to the at least one second opening and the at least one first opening, and a plurality of first internal circuits electrically connected with the pogo pins respectively;
wherein the probes of the probe module are MEMS probes formed on the probe substrate and electrically connected with the circuit board through the first internal circuits and the pogo pins respectively.

23. The optical inspection device as claimed in claim 1, wherein the mounting plate is disposed on the bottom surface of the circuit board and provided with an interposer including an interposing substrate, a plurality of first resilient interconnection elements electrically connected with the circuit board, and a plurality of second resilient interconnection elements; wherein the probe module is disposed on the bottom surface of the mounting plate and comprises:
a probe substrate connected with the mounting plate in a way that the mounting plate is interposed between the circuit board and the probe substrate; the probe substrate being provided with a fourth opening corresponding to the at least one second opening and the at least one first opening, and a plurality of first internal circuits electrically connected with the second resilient interconnection elements respectively;
wherein the probes of the probe module are MEMS probes formed on the probe substrate and electrically connected with the circuit board through the first internal circuits and the interposer respectively.

24. The optical inspection device as claimed in claim 1, wherein the mounting plate is disposed on the top surface of the circuit board and the probe module is disposed on the bottom surface of the circuit board and provided with the probes that are vertical-cantilever probes, and a probe holder for holding the vertical-cantilever probes; wherein the probe holder has a third opening corresponding to the at least one second opening; the optical inspection device further comprises an electrically conductive layer disposed between the probe holder and the circuit board and electrically connected with the vertical-cantilever probes and the circuit board.

25. The optical inspection device as claimed in claim 1, wherein the mounting plate is disposed on the top surface of the circuit board and provided with a sixth opening corresponding to the at least one first opening; wherein the probe module is disposed on the bottom surface of the circuit board and provided with the probes that are vertical-cantilever probes; wherein the probe module further comprises a probe holder for holding the vertical-cantilever probes; wherein the probe holder is connected with the circuit board in a way that the circuit board is interposed between the mounting plate and the probe holder; the probe holder has a third opening corresponding to the at least one second opening; the vertical-cantilever probes are electrically connected with the circuit board.

26. The optical inspection device as claimed in claim 1, wherein the mounting plate is disposed on the bottom surface of the circuit board and the probe module is located beneath the bottom surface of the circuit board; the probes of the probe module are cantilever probes; the probe module further comprises a probe holding ring for holding the cantilever probes; the probe holding ring is connected with the mounting plate in a way that the mounting plate is interposed between the circuit board and the probe holding ring; the cantilever probes are electrically connected with the circuit board.

27. The optical inspection device as claimed in claim 1, further comprising at least one position adjusting structure configured corresponding to the at least one second opening and the at least one lens holder and formed with the mounting plate and the at least one lens holder for enabling the at least one lens holder to do the position adjusting motion in the at least one second opening.
